(19) United States
(12) Patent Application Publication
(10) Pub. No.: US 2002/0176326 A1
(43) Pub. Date: Nov. 28, 2002

(54) Upload activates features of a dictation machine

(75) Inventor: Manfred Hoerndl, Horn (AT)

Correspondence Address: Corporate Patent Counsel, U.S. Philips Corporation, 580 White Plains Road, Tarrytown, NY, 10591, US

(73) Assignee: KONINKLIJKE PHILIPS ELECTRONICS N.V.

(21) Appl. No.: 10/151,047

(22) Filed: May 20, 2002

(30) Foreign Application Priority Data
May 22, 2001 (EP) 01 890 151.2

(51) Int. Cl. G11B 19/00; H04M 1/64

(52) U.S. Cl. 369/25.01; 379/75

(57) ABSTRACT

For the setting of functions of a dictating machine (1), the dictating machine is connected to a separate computer unit (12), on which individual setup information is defined, which is then fed to function control means (24) with associated setup memory means (25) provided in the dictating machine (1), and stored in the setup memory means (25).

The invention relates to a dictating machine for the recording and playback of verbal texts, further a dictation and transcription system having at least one such dictating machine and a separate computer unit, and finally also a method for the setting of functions of such a dictating machine. The dictating machine is, in particular, a digital dictating machine, preferably a hand-held machine, but possibly also a desktop machine.

Dictating machines, especially hand-held dictating machines, usually have set functions, provision possibly being made, apart from the basic functions of recording, playback, stop, fast forward and fast rewind, for additional functions such as marking of data files, marking of insertion points and the transfer of dictation data files to a memory storage unit of a computer unit, especially with voice recognition system and word processing. In such cases these functions are also set manually on the dictating machine.

If the scope is to be provided, however, for choosing from a number of special functions on the dictating machine, a limit to the number of manual setting facilities on the dictating machine is soon reached, since owing to the limited space available only a few keys and switches can be accommodated on the dictating machine itself. A multiplicity of keys and switches on the dictating machine would furthermore make normal operation thereof more difficult.

U.S. Pat. No. 4,817,127 A discloses a dictation system of modular design in which, while combining individual modules, such as recording/playback modules with sometimes identical functions, redundant functions on individual modules are suppressed in order to be able to make better use of other functions. At the same time, however, each function, such as the recording function or the playback function, is always identical in terms of operation.

These known digital dictation systems have the advantage that the dictation data files are transferred on a network to those points where, according to the verbal texts, written texts are produced, possibly using voice recognition systems. In these systems the individual transcriptions can be produced according to any priorities or in the order that the dictation data files are transferred. Any physical transfer of recording media in the form of dictation cassettes or the like is not necessary with these digital dictation systems. In the actual dictation, however, operation is generally focussed, as stated above, on the basic functions, so that when transcribing the verbal texts only an insufficient amount of further information, particularly the author's instructions with regard to method of typing and printout of the text, can be taken into account. Where such instructions are also dictated in conjunction with the texts to be transcribed, this may lead to confusion, quite apart from the fact that time is needlessly wasted in dictating and listening to such instructions. Where automatic voice recognition systems are used it would, moreover, often also be desirable to automatically supply information regarding the author of the verbal text, so as to be able to analyze the verbal texts more quickly in the voice recognition system according to stored training samples recorded previously by the author. Furthermore, modem voice recognition systems in many cases have particular vocabularies for specialized fields such as engineering, electronics, medicine etc., so that automatic flagging of the particular specialized field would also be desirable. Specific automatic information with regard to the formatting of texts would also be desirable. Other functions of the dictating machine in which an individual setting would be advantageous are the direct or optional transfer of dictation data files to a computer unit, another conceivable option being to transmit only dictation data files provided with specific author identifications, only so-called EOL (End Of Letter) data files, that is complete dictation data files, or all dictations including those not yet completed. As already mentioned, such configuration of a “Setup” directly on the dictating machine goes well beyond the scope of possibilities afforded by current dictating machines, especially when it comes to hand-held dictating machines.

It is therefore an object of the invention to create remedies for this and to provide setting facilities for dictating machines, in particular digital dictating machines, possibly in combination as part of a dictation system without the need to make complex, time-consuming adjustments to the dictating machine for this purpose.

To achieve this object, the invention proposes a dictating machine for the recording and playback of verbal texts, having electro-acoustic transducers, a recording and playback circuit and at least one manually operatable control switch for recording, playback, stop, fast forward and fast rewind, and furthermore having electronic function control means and associated setup memory means for the storage of individual setup information, which can be fed in from an external computer unit by way of means of connection.

A dictation and transcription system is accordingly provided, which is designed with at least one dictating machine for the recording and playback of verbal texts, having electro-acoustic transducers, a recording and playback circuit and at last one manually operatable control switch for recording, playback, stop, fast forward and fast rewind, and with a separate computer unit, the computer unit being set up in order to create a configuration of individual setup information for the dictating machine, and the dictating machine being provided with electronic function control means and associated setup-memory means for the storage of individual setup information, which can be fed in from the computer unit via means of connection.

According to a further aspect the invention proposes a method for the setting of functions of a dictating machine, the dictating machine being connected to a separate computer unit, on which individual setup information is defined, which is then fed to electronic function control means with associated setup memory means present in the dictating machine, and stored in the setup memory means.

In the system according to the invention, a dictating machine setting, a “setup”, is configured outside the dictating machine on an external computer unit, the desired settings being defined in particular in the form of individual items of setup information. These items of setup information are then fed to the dictating machine, more specifically to the setup memory means, these setup memory means being assigned to electronic function control means—generally a microprocessor or microcontroller. Storing the setup information, as previously compiled on the external computer unit, in the setup memory means in the dictating machine accordingly results, through interaction with the electronic function control means, in a dictating machine setting that meets the individual requirements of the user, it being possible in many cases—depending on the given facilities—to set automatic functions. On the other hand, it is also possible, without such setting via an external computer unit, to set the dictating machine in a basic setting, that is a basic mode in which the common functions, usual for the operation of a dictating machine, are fixed. In this way the user can be provided from the outset with a conventionally operated dictating machine, and if the user does not require any special functions, he can also use the dictating machine as part of a dictation system in the accustomed way. If specific functions are required, however, such as an automatic author flag with a view to retrieving comparative voice samples in a voice recognition system when converting dictation data files into text data files, or the provision of instructions regarding specific text formats, according to preselected types of document (for example, writs or memos for use in legal chambers), such information can be automatically provided and transferred as attributes to dictation or voice data files, if a transcription is to be made of the verbal text. The computer unit on which these transcriptions are to be prepared is preferably equipped with corresponding automatic recognition means in order to automatically convert the instructions associated with the default settings. If necessary, however, a corresponding instruction can also be displayed on the screen for the operators.

In order to be able to provide voice data files in the dictating machine with corresponding attributes and to store these, the function control means appropriately activate the recording and playback circuit of the dictating machine according to the stored setup information. A display may furthermore be provided on the dictating machine, which serves to display the set functions of the function control means according to the stored setup information. The user can thereby be visually informed at any time of the configuration of the dictating machine or that part of the configuration currently in use. With regard to the special instructions in the transfer of dictation data files it is also proposed that the function control means should control delivery of stored voice data files via an interface to an external computer unit according to the stored setup information.

As already mentioned, the dictating machine is preferably a digital dictating machine, and the recording and playback circuit is then designed with a digital voice processor device. A digital memory, that is a semiconductor memory, such as a so-called FLASH memory or a so-called SM card can then be assigned to this digital voice processor device, in order to store the verbal texts.

An advantageous procedure in defining the individual setup information is to initially transfer the dictating machine setup information, regardless of the current configuration of the machine, to the computer unit in a download operation, and then to amend, and if necessary supplement, this hitherto stored information according to the user's requirements, by making these amendments or additions on the computer unit controlled, for example, by means of a menu on the screen of the computer unit, and finally to store the amendments and additions; this current information is then transferred to the dictating machine in an upload operation. Transfer may be performed by cable or, where necessary, also by wireless means.

This makes it possible, if so required, to define an author flag, so that where a voice recognition system is used the voice recognition can be performed while purposely making reference to associated voice samples stored earlier by the author during “training”. A specialized field flag can also be defined, by means of which a suitable vocabulary, in the field of engineering, law or medicine, for example, can be purposely made available in the course of digital speech recognition. It is also possible, for retrieving default formats during subsequent word processing, to define document type flags as individual setup information. It is thereby possible to flag dictation data files from the outset as memos, for example, or as writs, as technical descriptions or as reports, an associated format being selected accordingly when transcribing in the course of the word processing. If, in the case of a writ, for example, existing file data already in the computer system are then also inserted in addition, preferably also as special, retrievable setup information, the addressee and parties, for example, can automatically also be inserted in multi-party litigation proceedings.

The invention will be further described with reference to examples of embodiment shown in the drawings to which, however, the invention is not restricted, and with reference to the attached drawings, in which:

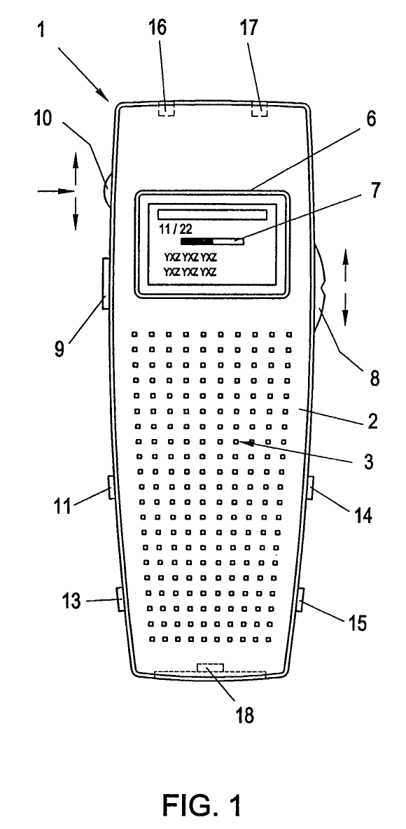

FIG. 1 shows a diagrammatic view of a hand-held dictating machine with operating switches drawn in diagrammatically;

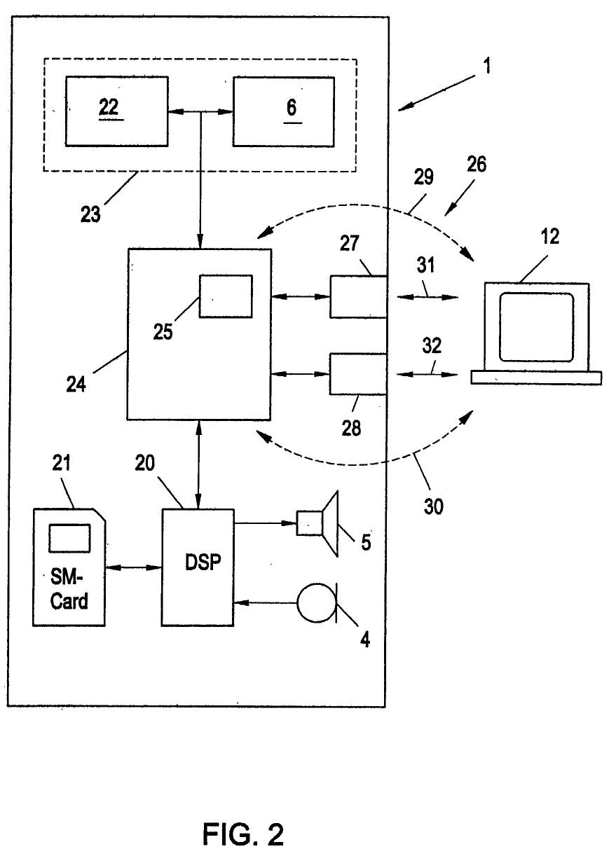

FIG. 2 shows a block diagram of such as hand-held dictating machine in a digital embodiment, an external computer unit in the form of a personal computer (PC) also being illustrated;

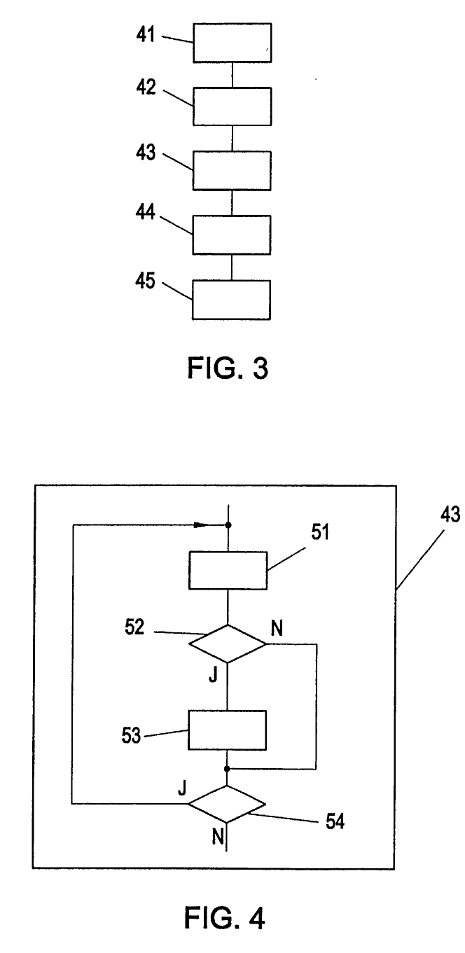

FIG. 3 shows a flow-chart illustrating the procedure for individual configuration, i.e. the defining of setup information and storage of this setup information in the digital dictating machine; and

FIG. 4 shows a part of this procedure according to FIG. 3 in more detail.

FIG. 1 shows a digital hand-held dictating machine 1, the casing 2 of which has a perforated wall area 3 on the front face, behind which electro-acoustic transducers, that is a microphone 4 and a loudspeaker 5 (cf. FIG. 2), are arranged. Also provided on the front face of the casing 2 is a conventional display 6 known in the art, on which various displays, especially alphanumeric and graphic displays are shown, depending on the configuration and mode set. For example, a bar chart display 7 is also possible in order to show what memory capacity is already occupied or still free, or how much dictation data has already been transferred or is still to be transferred when transferring it to a computer unit.

Various function switches are arranged, for the most part conventionally, in an ergonomic arrangement at the edge of the casing 2. Thus a usual four-position switch, operated by the thumb when holding the dictating machine 1 normally, is situated on the narrow right-hand side of the dictating machine 1 in the representation according to FIG. 1. This four-position switch 8 serves, in conjunction with a switch 9 on the other narrow side of the dictating machine 1 that is operated by the middle finger—according to the arrangement usual in Europe or the USA—for conventional control in recording (REC), playback (PLAY), stopping (STOP), fast forward (FFWD) and fast rewind (FRWD). A rotary press switch, a so-called “Jog Shuttle”, 10 operated by the index finger, serves in the basic set-up of the dictating machine 1 for increasing or reducing the volume in playback by rotating it upwards or downwards, see the upward and downward arrows, and for fixing the volume by pressing the switch 10 inwards. In special settings, this jog shuttle switch 10 has other functions such as, in particular, “scrolling” information that is to be selected upwards or downwards on the display 6 a line at a time, the information selected finally being confirmed, i.e. fixed, by pressing the jog shuttle switch 10. In this way, for example, author or dictation type flags that have been entered can be selected as shown on the display 6 in order to assign these flags to a specific dictation data file.

A download switch 11 serves, depending on the setting of the dictating machine 1 to transfer verbal texts, that is dictation data files, either individually at a separate press of the switch, or all together to a computer unit, a PC (cf. 12 in FIG. 2). A further switch 13, a so-called EOL switch (EOL—End of Letter, i.e. a finished dictated document) serves to mark completed dictations, it being possible to ensure that only completed, finished dictation data files are transferred to the computer unit 12.

Finally, on the opposite narrow side of the dictating machine 1 there is a switch 14 that serves for switching between an insertion mode and an “overwrite” mode, together with an erase switch 15, by means of which verbal texts can be erased.

In the embodiment according to FIG. 1 the dictating machine 1, on its top narrow side, furthermore has connections 16, 17 for a microphone and for headphones, and on the bottom narrow side there are connections 18, in the form of a socket and/or in the form of contact surfaces for connection to the associated computer unit, especially to the computer unit 12 according to FIG. 2.

According to FIG. 2 the digital dictating machine 1 has a recording- and playback circuit 20 in the form of a digital voice processor device, which is connected to a semiconductor memory 1, in particular an SM memory card 21, in order to store verbal texts recorded via the microphone 1 on this memory card 21, or to playback stored dictations through the loudspeaker 5. This is controlled via the function keys already described with reference to FIG. 1, which in FIG. 2 are diagrammatically combined in a block 22, which is part of a user interface denoted by 23 and shown by dashed lines, and which is connected to electronic function control means 24 in the form of a microcontroller. The microcontroller 24 is in turn connected to the digital voice processor device 20. The microcontroller 24 also activates the display 6, already mentioned, in an inherently conventional manner, in order to make the respective visual information including, in particular, the display bar 7, visible to the user, according to the operating mode and the setting,.

The microcontroller 24, together with the setup memory means 25 assigned thereto, serves to enable special functions according to an externally defined configuration with the dictating machine 1. Such special functions, i.e. individual setup information, that go beyond a basic mode of the dictating machine 1, are defined on the computer unit 12 according to a configuration menu implemented there, and are then fed to the dictating machine 1, specifically to its microcontroller 24 or setup memory means 25, in an upload operation by way of connection means indicated only diagrammatically at 26 in FIG. 2. In this case inherently conventional means of connection, particularly ones with interfaces such as a USB (Universal Serial Bus) interface 27 for cable transfer, and/or an interface 28 for wireless communication, can be connected to the microcontroller 24.

For configuration of the dictating machine 1, as described in more detail below, the existing configuration can first be transferred in a download operation from the dictating machine 1 to the computer unit 12, where the configuration is reset according to the requirements of the other user, following which it is transferred back to the dictating machine 1 in an upload operation and stored there. In FIG. 2 this configuration information is indicated at 29 and 30 by dashed lines between the microcontroller 24 and the computer unit 12. The two solid double arrows 31, 32, by contrast, are intended to show the transfer of user data.

In order to configure the setup of the dictating machine 1 according to the personal requirements of the user, use is made, as already stated, of the computer unit 12, on which the setting of individual functions, i.e. the defining of individual items of setup information, can easily be carried out with the aid of appropriate application software.

For this purpose a connection (e.g. a cable connection) is first made between the dictating machine 1 and the computer unit 12, cf. block 41 in FIG. 3, as shown diagrammatically in a flow chart in FIG. 3. According to Block 42 the current setup existing in the dictating machine 1, i.e. the collection of setup information stored there, is transferred to the computer unit 12 in a download operation by way of this connection. As further indicated in simplified form by a block 43, modifications, including any additions, required by the user, are now made to the configuration, so that a new individual collection of setup information is defined, which is then transferred, according to Block 44, in an upload operation from the computer unit 12 to the dictating machine 1 for adjustment of the latter. Finally, according to Block 45, the dictating machine 1 is separated from the computer unit 12 again.

FIG. 4 shows in somewhat clearer detail, the procedure for amending or supplementing the setup information according to Block 43. In this process, an item of setup information, one of a number, the order of which is defined, for example by the application software, is displayed according to block 51, and according to the decision block 52 it is inquired whether an amendment of this special setup information is required. If so, this amendment is undertaken according to Block 53, and it is then inquired, according to a decision block 54, whether further setup adjustments are required; if not, block 53 is skipped and the procedure moves directly to this next decision block 54. If further setup information is to be displayed, possibly amended, but at least examined, the procedure is returned from the decision block 54 to block 51. If no further setup adjustments are required, the end of this configuration stage is reached according to block 43 so that, as stated, the setup information can be transferred to the dictating machine 1 according to block 44.

In the course of the configuration process described, for example, it is possible to undertake the following setting on the dictating machine 1:

automatic transfer of dictation data files immediately on establishing the connection between dictating machine 1 and computer unit 12, or transfer of the dictation data files only after pressing the corresponding switch (11 in FIG. 1).

transfer of all dictation data files or solely those dictation data files identified as complete (EOL dictation data files) or of specific, selected dictation data files, e.g. only those dictation data files that are ascribed to a particular author.

European or American method of writing the date.

automatic erasure of dictation data files after transfer to the computer unit 12.

suppression or enabling of audible warnings by the dictating machine 1 (e.g. audible warning can be provided, if the memory card 21 is full or if the battery provided as power supply for the dictating machine 1 is discharged).

activation or deactivation of the display bar 7 on the display 6, particularly when displaying the state of the transfer (download) of the dictation data files from the dictating machine 1 to the computer unit 12.

In a separate profile setting, it is further possible, for example, to define more than one (e.g. two) sets each comprising a number of items of “profile information” (e.g. ten each), in order define setup information for quite specific purposes. In so doing it is particularly advantageous if file designations and document types can be fixed, in order to record “files” assigned to specific clients or patients and at the same time documents types, such as memos, reports, writs, rejoinders etc. with corresponding format instructions. Another configuration possibility here is to indicate a flag for an author or multiple authors, voice samples of the respective authors usually having been stored in the voice recognition system at an earlier date in the case of digital voice recognition, so that with such an author flag voice recognition can then be performed purposely with reference to the respective associated voice sample.

Yet another problem in the case of voice recognition is that a different vocabulary, a different library with specialist terms might have to be retrieved for each specialized field, as in the case of technical fields, medical fields or legal fields, for example, possibly with yet further sub-divisions (e.g. “engineering”-“electronics”-“chemistry”etc.). Here too, it is advisable to insert a corresponding flag from the outset when defining the setup information, so that when using the dictating machine 1 the respective specialized field can easily be sought and confirmed by means of the jog shuttle switch 10, so that an appropriate instruction (an attribute) is added to the dictation data file.

This attribute may naturally also be combined with other attributes, such as the author flag mentioned and document type and/or file designation flag.

The aforementioned special items of setup information are naturally to be taken merely as examples, and the person skilled in the art will be capable, according to the objective and sphere of application, of providing a wide variety of other set-up information for adjustment of the dictating machine 1 in the process of configuration on the PC, or an external computer unit 12 in general. Thus it is also feasible, for example, to store special instructions, such as instructions to personnel responsible for transcribing the text, these instructions needing to be marked, in particular, where a voice recognition system is used, in order that the voice recognition system recognizes these instructions as such and does not incorporate them into the word processing.

1. A dictating machine (1) for the recording and playback of verbal texts, having electro-acoustic transducers (4, 5), a recording and playback circuit (20) and at least one manually operated control switch (8, 9) for recording, playback, stop, fast forward and fast rewind, and furthermore having electronic function control means (24) and associated setup memory means (25) for the storage of individual setup information that can be supplied by an external computer unit (12) by way of connection means (26).

2. A dictating machine (1) as claimed in claim 1, characterized in that the function control means (24) are designed to control the recording and playback circuit (20) according to stored setup information.

3. A dictating machine (1) as claimed in claim 1, characterized in that the function control means (24) are designed to control a display (6) according to stored setup information for the purpose of displaying set functions.

4. A dictating machine (1) as claimed in claim 1, characterized in that the function control means (24) are designed to control the delivery of stored voice data to an external computer unit (12) by way of an interface (27, 28) according to stored setup information.

5. A dictating machine (1) as claimed in claim 1, characterized in that the function control means (24) take the form of a microcontroller.

6. A dictating machine (1) as claimed in claim 1, characterized in that the recording- and playback circuit (20) comprises a digital voice processor device.

7. A dictating machine (1) as claimed in claim 6, characterized in that a digital memory, such as an SM memory card (21), is assigned to the digital voice processor device as voice data memory.

8. A dictation and transcription system having at least one dictating machine (1) for the recording and playback of verbal texts, having electro-acoustic transducers (4, 5), a recording- and playback circuit (20) and at least one manually operated control switch (8, 9) for recording, playback, stop, fast forward and fast rewind, and having a separate computer unit (12), characterized in that the computer unit (12) is designed for compiling a configuration of individual setup information for the dictating machine (1), and characterized in that the dictating machine (1) is provided with electronic function control means (24) and associated setup memory means (25) for the storage of individual setup information supplied by the computer unit (12) by way of connection means (26).

9. A dictation and transcription system as claimed in claim 8, characterized in that the function control means (24) are designed to control the recording- and playback circuit (20) according to stored setup information.

10. A dictation and transcription system as claimed in claim 8, characterized in that the function control means (24) are designed to control a display (6) according to stored setup information for the purpose of displaying set functions.

11. A dictation and transcription system as claimed in claim 8, characterized in that the function control means (24) are designed to control the delivery of stored voice data to an external computer unit (12) by way of an interface (27, 28) according to stored setup information.

12. A dictation and transcription system as claimed in claim 8, characterized in that the function control means (24) take the form of a microcontroller.

13. A dictation and transcription system as claimed in claim 8, characterized in that the recording- and playback circuit (20) comprises a digital voice processor device.

14. A dictation and transcription system as claimed in claim 1, characterized in that a digital memory, such as an SM memory card (21), is assigned to the digital voice processor device as voice data memory.

15. A method for the setting of functions of a dictating machine (1), characterized in that the dictating machine (1) is connected to a separate computer unit (12), on which individual setup information is defined, which is then fed to electronic function control means (24) with associated setup memory means (25) provided in the dictating machine (1), and stored in the setup memory means (25).

16. A method as claimed in claim 15, characterized in that before defining the individual setup information the current setup information stored in the setup memory means (25) is fed from the dictating machine (1) to the computer unit (12), following which this current setup information is amended on the computer unit (12) in order to define new individual setup information.

17. A method as claimed in claim 15, characterized in that the transfer of the respective setup information is by cable.

18. A method as claimed in claim 15, characterized in that the dictating machine (1) is initially set using setup information according to a simple basic mode, which comprises the recording and playback of voice data, stop and a fast forward and rewind.

19. A method as claimed in claim 15, characterized in that at least one author flag is defined as individual setup information, to which a reference to stored associated voice samples is linked in the case of digital voice recognition.

20. A method as claimed in claim 15, characterized in that at least one specialized field flag is defined as individual setup information, to which a reference to an associated vocabulary library is linked in the case of digital voice recognition.

21. A method as claimed in claim 15, characterized in that at least one document type flag is defined as individual setup information.
